(19) United States
(12) Patent Application Publication
(10) Pub. No.: US 2022/0364752 A1
(43) Pub. Date: Nov. 17, 2022

(54) System and Method for Controlling Consumption of Energy

(71) Applicant: Edward Levene, Stamford, CT (US)

(72) Inventor: Edward Levene, Stamford, CT (US)

(21) Appl. No.: 17/654,498

(22) Filed: Mar. 11, 2022

Related U.S. Application Data
(60) Provisional application No. 63/187,120, filed on May 11, 2021.

(51) Int. Cl. F24F 11/47; G06Q 50/06; F24D 13/04

(52) U.S. Cl. CPC F24F 11/47; G06Q 50/06; F24D 13/04; F24F 2110/12

(57) ABSTRACT

A control system for controlling consumption of energy in an environment including a controller having a processor and a real time clock, the real time clock being configured to coordinate operations of the processor with timing of the designated peak period, the processor being configured to determine a minimum pre-operating period and to signal an air conditioning and/or space heating system to enter an operating state for at least the minimum pre-operating period before the designated peak period begins and enter a non-operating state after the designated peak period begins; an operating program having processing parameters and processing procedure for determining the minimum pre-operating period, wherein the processing parameters and processing procedure comprise determining the minimum pre-operating period using thermal mass of the environment, costs for the consumption of energy, and efficiency of the air conditioning and/or space heating system.

### CROSS-REFERENCE TO RELATED APPLICATIONS

This application claims the benefit, under 35 U.S.C. § 119(e), of U.S. Provisional Application Ser. No. 63/187,120, filed on May 11, 2021, the content of which is incorporated herein by reference in its entirety.

### TECHNICAL FIELD

The present teachings relate generally to a control system and method, and more specifically to a control system and method for controlling consumption of energy in an environment.

### BACKGROUND

In many modern urban and industrial areas, energy rates vary at different times during the day. Energy costs during “peak hours” are greater than costs during the remaining hours. To economically use energy in an environment that has a variable rate schedule, a complex response strategy is required.

Moreover, the recent development of state of the art, controller-regulated air conditioners, heating systems, or heating, ventilation, and air conditioning (HVAC) systems that operate at multiple speeds or modes have added a new factor in a control strategy for economic cooling or heating. However, there is still room for better energy efficiencies in the environment that includes such air conditioners, heating systems, or HVAC systems.

Further, the environmental concerns such as the pollution caused by carbon dioxide emission has drawn a lot of attention. A system to improve environment benefits is required when using energy.

Thus, there exists a need for a control system to get better cost efficiencies, energy efficiencies, and/or environmental benefits to address and overcome the above-mentioned problems in the art.

### SUMMARY

The needs set forth herein as well as further and other needs and advantages are addressed by the present embodiments, which illustrate solutions and advantages described below.

It is an object of the present teachings to provide a strategic-response control system and process for controlling consumption of energy in an environment to reduce the energy costs, the installed capacity allocation costs, the distribution demand charges, the local distribution costs, the transmission costs, and all other related costs.

It is an object of the present teachings to provide a strategic-response control system and process for controlling consumption of energy including electricity, natural gas, fuel oil, propane, or other fuel in an environment to better utilize an air conditioning system, heating system, or HVAC system, such as utilize greater efficiency of the air conditioning system, heating system, or HVAC system during lower or higher outside temperatures.

It is an object of the present teachings to provide a strategic-response control system and process to reduce related energy consumption and/or reduce related carbon dioxide emissions. The control system can create a certifiable report of the energy consumption reduction or carbon dioxide emissions reduction and maximize the energy consumption reduction credits or the carbon dioxide emissions reduction credits that can be used for trading. The control system can promote the installation of submetering to account for the electricity or energy consumption and provide measurement and verification to certify the changes potentially at ASHRAE 14 standards, for participation or expanded participation in demand response programs from the Utility, Regional Transmission Operator, State or Federal Government, for compliance with New York Local Law 97 (energy efficiency improvement law and Greenhouse Gas Reduction or penalties), for creating renewable energy credits under Massachusetts Clean Peak Standard program, which is designed to provide incentives to clean energy technologies that can supply electricity or reduce demand during seasonal peak demand periods established by Massachusetts Department of Energy Resources (DOER), for altering the timing of use of electricity and receiving economic incentives in programs like the emergency California Market Flex Program which is designed to shift or reduce power after the solar production decreases when the sun is lowering in the afternoon until use diminishes at night and prevent possible rolling blackouts, for creating carbon dioxide emission reduction certificates or certified quantities for trading on the Chicago Mercantile Exchange (CME) or other sales or platform format, for having an electric supply agreement to rebate some or all of the economic benefits to the meter owner or contracted energy manager, for providing a rider to the electric supply agreement that includes language that a reduction in the installed capacity for future periods of the supply agreement caused by the process will be rebated at the negotiated rates to the appropriate party, for providing a rider to the electric supply agreement that includes language that a transfer of power from higher cost or hedged on-peak periods to lower cost off-peak periods caused by the process will be rebated at the negotiated rates to the appropriate party, and for taking over energy management with the process and selling the power under contract at a reduced fixed rate or sharing formula of the benefits caused by the process.

It is another object of the present teachings to use a building's existing thermal mass and air conditioning system to reduce peak demand, provide demand response, and/or generate incentive payments for economic purposes. It is another object of the present teachings to use the building's thermal mass as energy storage to shift usage to reduce energy consumption and increase incentive payments.

It is another object of the present teachings to cause more consumption of a building's energy with off-peak energy costs, off-peak distribution, and off-peak transmission costs using a building thermal mass and the building's air conditioning or heating system.

It is another object of the present teachings to use calculations of the thermal mass capacity of the building and the air conditioning system, heating system, or HVAC system to store energy with electricity, natural gas, fuel oil, propane, or other fuel converted into cooling or heating in the building mass in advance of the change in pricing to higher levels of the components, as the off-peak distribution and off-peak transmission price and times and off-peak energy hours are known in advance, or when incentives to reduce power consumption during certain approaching periods are known in advance. The benefit is to lower energy costs and promote incentives while maintaining building's temperature in the desired range.

It is another object of the present teachings to use current and forward-looking components including any or all of the following: temperature, humidity, wind, air infiltration, cloud cover, angle of the sun on the building, intensity of the sun, forced air ventilation, cooling/heating capacity of the system, efficiency of the air conditioning and/or space heating system during the times prior to and up to times of the price or incentive changes.

It is another object of the present teachings to look for economic benefit from the off-peak to on-peak energy price, off-peak distribution rates to on-peak distribution rates, off-peak transmission rates to on-peak transmissions rates, incentives during certain periods to provide economic benefits by managing the change in pricing and benefits with the thermal mass energy storage capacity of a building and the air conditioning system, heating system, or HVAC system.

It is another object of the present teachings to reduce a building's associated carbon dioxide emissions by using a building's existing thermal mass as energy storage and the air conditioning system, heating system, or HVAC system. The use of more energy during non-peak periods or during periods having high solar electricity generation reduces associated carbon dioxide emissions for the building. This carbon dioxide reduction occurs as more efficient power plants, nuclear plants and wind power are operating during off-peak periods, or when solar production is high, lowering the associated carbon dioxide emissions during those periods related to energy consumption of the building by using the building's thermal mass as energy storage.

It is another object of the present teachings to include in the system metering devices to record consumption and create a verifiable analysis, measurement, and verification report to identify the consumption change to a baseline and the certifiable value for carbon dioxide reductions. The carbon dioxide emissions reductions may be traded or sold for economic value created by using the building's existing thermal mass as energy storage and the air conditioning system, heating system, or HVAC system.

It is another object of the present teachings to use the system to analyze which power plants are running and predict the future power plant operations to identify how much carbon dioxide is emitted per kWh during each period and use the system to increase consumption of energy during reduced carbon dioxide emitting periods and evaluate the economic benefits of carbon dioxide reduction credit trading.

It is another object of the present teachings to use the system to identify the periods requiring solar or wind to curtail or when energy prices are negative (like California) when generation produces more power than the grid can handle and “reverse the system” to use more power during these periods.

It is another object of the present teachings to use the system to recalculate actions to reduce operation during the critical periods and gain the economic incentives when a critical period of over demand is anticipated.

These and other objects of the present teachings are achieved by providing a control system for controlling consumption of energy in an environment. The control system comprises: a controller having a processor and a real time clock, the real time clock being configured to coordinate operations of the processor with timing of the designated peak period, the processor being configured to determine a minimum pre-operating period and to signal an air conditioning and/or space heating system (or a system controlling the air conditional system) to enter an operating state for at least the minimum pre-operating period before the designated peak period begins and enter a non-operating state after the designated peak period begins; an operating program having processing parameters and processing procedure for determining the minimum pre-operating period, wherein the processing parameters and processing procedure comprise determining the minimum pre-operating period using thermal mass of the environment, costs for the consumption of energy, and efficiency of the air conditioning and/or space heating system. The control system further comprises the air conditioning and/or space heating system in the environment that is alternately operated in the operating state and the non-operating state. Here, the air conditional and/or space heating system can also include a system that controls the air conditioning and/or space heating system. The energy may include at least one of electricity and natural gas.

The processing parameters and processing procedure further comprise determining the minimum pre-operating period using at least one of: real-time temperature, real-time humidity, real-time wind, real-time air infiltration, real-time cloud cover, real-time angle of sun, real-time intensity of sun, real-time building occupancy, predicted temperature, predicted humidity, predicted wind, predicted air infiltration, predicted cloud cover, predicted angle of sun, predicted intensity of sun, predicted building occupancy, predicted or planned forced air ventilation, and cooling/heating capacity of the air conditioning and/or space heating system in the environment. The costs for the consumption of energy further comprise at least one of: peak energy cost, off-peak energy cost, real time energy cost, peak distribution cost, off-peak distribution cost, peak transmission cost, off-peak transmission cost, demand charges, and curtailment incentives. Each of the peak energy cost, off-peak energy cost, real time energy cost, peak distribution cost, off-peak distribution cost, peak transmission cost, and off-peak transmission cost comprises multiple cost levels.

The processor is further configured to: receive a notice on current or expected insufficient energy generation or supply or elevated energy price in a region that includes the environment; and assign a time period as the designated peak period based on the notice. The processor is further configured to: receive and analyze energy generation or supply information in a region that includes the environment to predict an energy demand in the region; and assign a time period as the designated peak period based on the prediction of the energy demand. The processor is further configured to: receive operation information of power plants in a region that includes the environment and analyze carbon dioxide emission based on the operation information to predict carbon dioxide emission in the region; assign a time period as the designated peak period based on the prediction of the carbon dioxide emission. The processor is further configured to: receive information on curtailing full or partial operation of solar or wind power plants in a region that includes the environment for grid operational purpose, assign immediately or at a designated time period off the designated peak period based on the curtailing information.

The control system further comprises: an indoor sensor electronically connected to the controller and being configured to generate an input signal to the processor representing an indoor parameter as one of the processing parameters including at least one of temperature and humidity; an outdoor sensor electronically connected to the controller and being configured to generate an input signal to the processor representing an outdoor parameter as one of the processing parameters including at least one of temperature and humidity; a storage configured to store parameters of the environment, parameters of the air conditioning and/or space heating system, and parameters of cost for use in the processing parameters and processing procedure.

The operating state of the air conditioning and/or space heating system has multiple power levels including a low power level, and the processing parameters and processing procedure further comprises: designating a comfort level temperature; determining whether the comfort level temperature will be exceeded in the designated peak period by operating the air conditioning and/or space heating system in the non-operating state during the designated peak period; and determining a minimum peak-operating period using the thermal mass of the environment and the efficiency of the air conditioning and/or space heating system if it is determined that the comfort level temperature will be exceeded in the designated peak period by operating the air conditioning and/or space heating system in the non-operating state during the designated peak period; and wherein the processor is configured to determine the minimum pre-operating period and to signal the air conditioning and/or space heating system to enter the operating state at the low power level for at least the minimum peak-operating period during the designated peak period.

The processing parameters and processing procedure further comprises calculating a warmup or cooldown rate for the environment, and the operating program includes an algorithm for calculating the warmup or cooldown rate for the environment for a particular indoor temperature and a particular outdoor temperature. The operating state of the air conditioning and/or space heating system has multiple power levels, and the processing parameters and processing procedure further comprises calculating the warmup or cooldown rate for the environment using a table of relationship between warmup or cooldown rates and power levels of the operating state.

The control system further comprises a metering device configured to record the consumption of energy; and an analyzing device configured to analyze a consumption change or a related carbon dioxide emission change based on the consumption record. The analyzing device is further configured to generate a certifiable report on a reduction of energy consumption or related carbon dioxide emission.

The present teachings also provide a method for strategically controlling consumption of energy in an environment. The method comprises: (1) calculating a minimum pre-operating period using thermal mass of the environment, efficiency of the air conditioning and/or space heating system, and costs for the consumption of energy; (2) operating an air conditioning and/or space heating system in the environment in an operating state for at least the minimum pre-operating period before a designated peak period begins; and (3) operating the air conditioning and/or space heating system in a non-operating state after the designated peak period begins. The method may further comprise operating the air conditioning and/or space heating system and controlling the consumption of energy multiple times during a day to gain economic benefits.

The method further comprises receiving a notice on current or expected insufficient energy generation or supply or elevated energy price in a region that includes the environment; and assigning a time period as the designated peak period based on the notice. The method further comprises receiving and analyzing energy generation or supply or economic incentive information in a region that includes the environment to predict an energy demand or price (including economic incentive value) in the region; and assigning a time period as the designated peak period based on the prediction of the energy demand or price (including economic incentive value). The method further comprises receiving operation information of power plants in a region that includes the environment and analyzing carbon dioxide emission based on the operation information to predict carbon dioxide emission in the region; assigning a time period as the designated peak period based on the prediction of the carbon dioxide emission. The method further comprises receiving information on curtailing full or partial operation of solar or wind power plants in a region that includes the environment for grid operational purpose, assigning immediately or at a designated time period off the designated peak period based on the curtailing information.

The method further comprises calculating the minimum pre-operating period using at least one of: temperature, humidity, wind, air infiltration, cloud cover, angle of sun, intensity of sun, predicted temperature, humidity, wind, air infiltration, cloud cover, angle of sun, intensity of sun, forced air ventilation, and cooling/heating capacity of the air conditioning and/or space heating system in the environment. The costs for the consumption of energy comprises at least one of: peak energy cost, off-peak energy cost, peak distribution cost, off-peak distribution cost, real time energy cost, peak transmission cost, off-peak transmission cost, demand charges, and curtailment incentives. Each of the peak energy cost, off-peak energy cost, real time energy cost, peak distribution cost, off-peak distribution cost, peak transmission cost, and off-peak transmission cost comprises multiple cost levels.

The operating state of the air conditioning and/or space heating system has multiple power levels including a low power level, and the method further comprises: (1) designating a comfort level temperature in the environment; (2) determining whether the comfort level temperature will be exceeded in the designated peak period by operating the air conditioning and/or space heating system in the non-operating state during the designated peak period; (3) calculating a minimum peak-operating period using the thermal mass of the environment and the efficiency of the air conditioning and/or space heating system if it is determined that the comfort level temperature will be exceeded in the designated peak period by operating the air conditioning and/or space heating system in the non-operating state during the designated peak period; and (4) operating the air conditioning and/or space heating system at the low power level for at least the minimum peak-operating period during the designated peak period. The method further comprises calculating the minimum peak-operating period using at least one of: parameters of the environment, parameters of the air conditioning and/or space heating system, and parameters of cost.

The method further comprises: (1) sensing an indoor temperature and sensing an outdoor temperature; (2) determining a warmup or cooldown rate for the environment based on the indoor temperature and the outdoor temperature; and (3) calculating the minimum peak-operating period using the warmup or cooldown rate. The operating state of the air conditioning and/or space heating system has at least three power levels including the low power level and a next power level above the low power level, and the method further comprises: (1) determining whether the minimum peak-operating period exceeds a remaining time period of the designated peak period; (2) calculating a second minimum peak-operating period using the thermal mass of the environment and the efficiency of the air conditioning and/or space heating system if it is determined that the minimum peak-operating period exceeds the remaining time period of the designated peak period; and (3) operating the air conditioning and/or space heating system at the next power level above the low power level for at least the second minimum peak-operating period during the designated peak period. The method further comprises calculating the second minimum peak-operating period using at least one of: parameters of the environment, parameters of the air conditioning and/or space heating system, and parameters of cost.

The method further comprises designating a peak period. Designating the peak period is based on at least one of: parameters of the environment, parameters of the air conditioning and/or space heating system, parameters of cost, parameters of energy supply and demand, and parameters of carbon dioxide emission.

The method further comprises analyzing an energy cost. The method further comprises calculating the minimum pre-operating period based on the analysis of the energy cost. The method further comprises analyzing an energy consumption. The method further comprises calculating the minimum pre-operating period based on the analysis of the energy consumption. The method further comprises analyzing a carbon dioxide emission. The method further comprises calculating the minimum pre-operating period based on the analysis of the carbon dioxide emission. The method further comprises recording the consumption of energy; and analyzing a consumption change based on the consumption record. The method further comprises analyzing a carbon dioxide emission change based on the consumption record. The method further comprises generating a certifiable report on a reduction of energy consumption or carbon dioxide emission to be used for carbon dioxide emission credit's purpose, economic purpose, regulatory purpose, or regulatory compliance.

The present teachings also provide a control system for controlling consumption of energy in an environment. The control system comprises: a controller having a processor and a real time clock, the real time clock being configured to coordinate operations of the processor with timing of a period, the processor being configured to designate a peak period and an off-peak period, determine a first operating period for the designated peak period and to signal an air conditioning and/or space heating system to enter a first operating state for at least the first operating period during the designated peak period and enter a non-operating state for rest of the designated peak period, and determine a second operating period for the designated off-peak period and to signal the air conditioning and/or space heating system to enter a second operating state for at least the second operating period during the designated off-peak period and enter the non-operating state for rest of the designated off-peak period; an operating program having processing parameters and processing procedure for determining the first operating period and the second operating period, wherein the processing parameters and processing procedure comprise determining the first operating period and the second operating period using thermal mass of the environment, costs for the consumption of energy, and efficiency of the air conditioning and/or space heating system.

The processing parameters and processing procedure further comprises determining the first operating period and the second operating period using parameters of the environment and parameters of the air conditioning and/or space heating system in the environment.

The parameters of the environment comprise real-time temperature, real-time humidity, real-time wind, real-time air infiltration, real-time cloud cover, real-time angle of sun, real-time intensity of sun, real-time building occupancy, predicted temperature, predicted humidity, predicted wind, predicted air infiltration, predicted cloud cover, predicted angle of sun, predicted intensity of sun, predicted building occupancy, and the parameters of the air conditioning and/or space heating system in the environment comprise cooling/heating capacity of the air conditioning and/or space heating system and running time of the air conditioning and/or space heating system. The costs for the consumption of energy comprise peak energy cost, off-peak energy cost, real-time energy cost, peak distribution cost, off-peak distribution cost, real-time distribution cost, peak transmission cost, off-peak transmission cost, real-time transmission cost, demand charges, and curtailment incentives.

Designating the peak period and the off-peak period is based on at least one of: parameters of the environment, parameters of the air conditioning and/or space heating system, parameters of cost, parameters of energy supply and demand, and parameters of carbon dioxide emission.

The processor is further configured to analyze an energy cost. The processor is further configured to determine the first operating period and the second operating period based on the analysis of the energy cost. The processor is further configured to analyze an energy consumption. The processor is further configured to determine the first operating period and the second operating period based on the analysis of the energy consumption. The processor is further configured to analyze a carbon dioxide emission. The processor is further configured to determine the first operating period and the second operating period based on the analysis of the carbon dioxide emission.

The control system is further configured to evaluate and/or adjust the amount of forced outdoor air ventilation at multiple periods during the day while monitoring the carbon dioxide emission levels inside the building to maintain a rule compliant environment or pre-charge the environment with excess forced outdoor air ventilation in combination with the building's thermal mass and economic considerations. The strategic-response control system may use forced outdoor ventilation adjustments (e.g., increases and decreases) as a component of the analysis to reduce energy consumption during specific hours while maintaining the building environment within legal or administrative requirements including carbon dioxide levels.

Other features and aspects of the present teachings will become apparent from the following detailed description, taken in conjunction with the accompanying drawings, which illustrate by way of example the features in accordance with embodiments of the present teachings. The summary is not intended to limit the scope of the present teachings, which is defined by the claims included herein.

### BRIEF DESCRIPTION OF THE DRAWINGS

FIG. 1 is a block diagram of a control system according to the present teaching.

FIG. 2 is a block diagram illustrating the processing parameters used in a processing procedure in the control system according to the present teachings.

FIG. 3 is a flow chart illustrating a processing procedure in the control system according to one embodiment of the present teachings.

FIG. 4 is a flow chart illustrating a processing procedure in the control system according to another embodiment of the present teachings.

### DETAILED DESCRIPTION

The present teachings are described more fully hereinafter with reference to the accompanying drawings, in which the present embodiments are shown. The following description illustrates the present teachings by way of example, not by way of limitation of the principles of the present teachings.

The present teachings have been described in language more or less specific as to structural features. It is to be understood, however, that the present teachings are not limited to the specific features shown and described, since the product herein disclosed comprises preferred forms of putting the present teachings into effect.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. Other than in the operating examples, or where otherwise indicated, all numbers expressing quantities of ingredients or reaction conditions used herein are to be understood as modified in all instances by the term “about”.

The strategic-response control system according to the present teachings regulates air conditioning or space heating systems for economical or environmental operation in a variable environment. The strategic-response control system takes advantage of the thermal mass characteristics of the environment and the air conditioning and/or space heating system being regulated and considers the costs, incentives, and/or environmental effects. It is noted that a plurality of the air conditioning or space heating systems can be controlled by the control system according to the present teachings so that the systems coordinate and work as a whole for economical or environmental purposes.

A variable environment is typically one where energy charges during one or more periods during the day or week exceed normal rates in order to encourage energy reduction during times that energy use strains the capacity of an energy supplier to meet energy demands. In modern energy supply networks, a utility provider is frequently charged higher rates for power delivered by networked power suppliers during periods of power scarcity due to increased energy demands by the end user. These charges are passed on to the customer by increased rates for energy (e.g., electricity) during certain high-use periods of the day, for example, from 3 p.m. to 9 p.m. during the weekday. The rates during this period may be four or five times the rate during other periods and encourage strategies of selective energy conservation having economic incentives. As another example, some programs encourage gas distribution utilities to reduce energy (e.g., natural gas) consumption during certain periods, for example, from 6 a.m. to 9 a.m. by providing economic incentives. The control system of the present teachings has been devised to generate significant savings in such multiple-rate environments and can be tailored for more complex rate systems.

The term “environment” refers to any building(s) under the control of the control system of the present teachings and the related surroundings. The term “air conditioning and/or space heating system” refers to any applicable heating, ventilation, and air conditioning (HVAC) systems, including fans and networked air conditioners or heaters preferably having multiple capacity levels of operation.

The terms “peak period,” “off-peak period,” and “mid-peak period” refer to time periods that requires a higher energy supply, a lower energy supply, and an energy supply between the previous two, respectively, and are defined relatively rather than fixed. The energy involved here includes electricity, natural gas, fuel oil, propane, other fuel, or any applicable type of energy.

The terms “operating state” and “non-operating state” refer to whether the air conditioning and/or space heating system is “on” and “off”, respectively. The term “operating state” may have multiple operating levels or modes. For example, the first operating level or mode may mean operation in the lowest power, or the first operating level or mode may mean operation with a specific objective such as reducing the humidity. The term “power level or mode” may mean operation in a certain power.

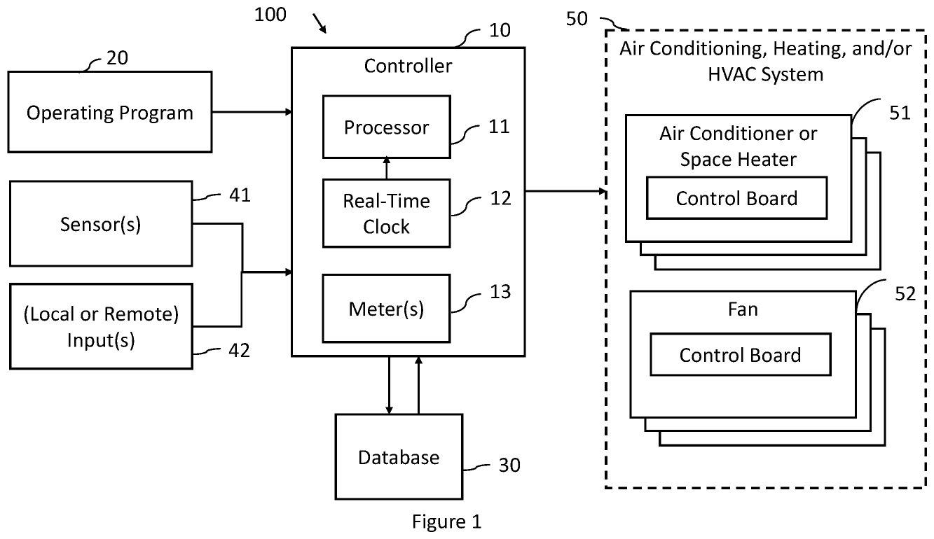

Referring to FIG. 1, a control system 100 for controlling consumption of energy in an environment is illustrated. The control system 100 may include a controller 10 connected to an air conditioning and/or space heating system 50. The control system 100 may further include an operating program 20, a database 30, a sensor(s) 41, or an input(s) 42.

The controller 10 may be a programmable controller. The controller 10 may include a processor 11 and a real-time clock 12. The real time clock 12 may coordinate operations of the processor 11 with timing of a time period such as a designated peak period. The processor 11 may determine a minimum pre-operating period including a starting time and an ending time and signal the air conditioning and/or space heating system (or a system controlling the air conditioner) 50 to enter an operating state for at least the minimum pre-operating period before the designated peak period begins and enter a non-operating state after the designated peak period begins. The processor 11 may determine a minimum after-operating period including a starting time and an ending time and signal the air conditioning and/or space heating system 50 to enter an operating state for at least the minimum after-operating period after the designated peak period ends. The processor 11 may determine an operating period including a starting time and an ending time for each of the peak period, the off-peak period, and the mid-peak period, and signal the air conditioning and/or space heating system 50 to enter the corresponding operating state for each period and to enter a non-operating state for the rest of each period.

The operating program 20 may have processing parameters and processing procedure for determining the minimum pre-operating period. The processing parameters and processing procedure may include determining the minimum pre-operating period using thermal mass of the environment, costs for the consumption of energy, and efficiency of the air conditioning and/or space heating system. In addition, the processing parameters and processing procedure may include determining the minimum pre-operating period in a way that the energy costs or consumption are minimized. Further, the processing parameters and processing procedure may include determining the minimum pre-operating period in a way that the carbon dioxide emission is minimized. Also, the processing parameters and processing procedure may include determining the minimum pre-operating period in a way that the incentives are maximized.

The operating program 20 may have processing parameters and processing procedure for determining the minimum after-operating period. The processing parameters and processing procedure may include determining the minimum after-operating period using thermal mass of the environment, costs for the consumption of energy, and efficiency of the air conditioning and/or space heating system. In addition, the processing parameters and processing procedure may include determining the minimum after-operating period in a way that the energy costs or consumption are minimized. Further, the processing parameters and processing procedure may include determining the minimum after-operating period in a way that the carbon dioxide emission is minimized. Also, the processing parameters and processing procedure may include determining the minimum after-operating period in a way that the incentives are maximized.

The operating program 20 may have processing parameters and processing procedure for determining the operating period. The processing parameters and processing procedure may include determining the operating period using thermal mass of the environment, costs for the consumption of energy, and efficiency of the air conditioning and/or space heating system. In addition, the processing parameters and processing procedure may include determining the operating period in a way that the energy costs or consumption are minimized. Further, the processing parameters and processing procedure may include determining the operating period in a way that the carbon dioxide emission is minimized. Also, the processing parameters and processing procedure may include determining the operation period in a way that the incentives are maximized.

The processing parameters and processing procedure may further include determining the minimum pre-operating period, the minimum after-operating period, or the operating period using at least one of: real-time or predicted temperature, real-time or predicted humidity, real-time or predicted wind, real-time or predicted air infiltration, real-time or predicted cloud cover, real-time or predicted angle of sun, real-time or predicted intensity of sun, real-time or predicted building occupancy, predicted or planned forced air ventilation, and cooling/heating capacity of the air conditioning and/or space heating system in the environment.

The operating program 20 may include the basic program for controlling the operation of the air conditioning and/or space heating system 10. The operating program 20 may include a look-up table used to generate and adjust parameters of operation together with updatable parts of the operating programs.

The database 30 may store all information that the controller 10 has communicated with other components of the system such as the operating program 20, the sensor(s) 41, the input(s) 42, and the air conditioning and/or space heating system 50. The database 30 may be a storage configured to store parameters of the environment, parameters of the air conditioning and/or space heating system, and parameters of cost for use in the processing parameters and processing procedure.

The air conditioning and/or space heating system 50 is alternately operated in the operating state and the non-operating state in the environment. The air conditioning and/or space heating system 50 may include at least one of an air conditioner(s) 51 and a fan(s) 52. Each of the conditioner(s) 51 and the fan(s) 52 may include a control board, which includes the electronics for a compressor capacity level control and/or a fan system control. It is to be understood that the control board may be incorporated as a part of the air conditioning and/or space heating system 50 or alternatively incorporated as a part of the controller 10.

For example, the air conditioner 51 or the fan 52 may have three operating levels or modes, and thus, may be operated as “on” with three operating states and as “off.” As another example, the air conditioner 51 or the fan 52 may only have a single operating level or mode, and thus, may be operated as “on” and as “off”. As a further example, the air conditioner 51 or the fan 52 may have three power levels or modes, and thus, may be operated as “on” with three operating states and as “off.” The air conditioner 51 or the fan 52 may have various power levels or various power modes, and thus, may be operated as “on” with various operating states and as “off.”

The controller 10 may further include a meter(s) 13. The meter(s) 13 may allow the controller 10 to sense the current and voltage and to coordinate the real-time clock 12 with the internal timing of the meter(s) 13. The meter(s) 13 may coordinate to receive input(s) 42 from a customer locally or remotely for entering the time of beginning and ending of energy usage. The meter(s) 13 may record the consumption of energy. It is to be understood that the meter(s) may be incorporated as a part of the controller 10 or alternatively separated and sold independently.

The controller 10 may further include an analyzing device (not shown) to analyze an energy or energy consumption change or a related carbon dioxide emission change based on the consumption record from the meter(s) 13. The analyzing device may generate a certifiable report on a reduction of energy or energy consumption or related carbon dioxide emission.

The controller 10 may coordinate with the input(s) 42 to control the operation of the air conditioning and/or space heating system 50. The input(s) 42 may be used for receiving, locally or remotely, information regarding the thermal mass of the environment, the costs for consumption of energy, and the efficiency of the air conditioning and/or space heating system, as well as other factors such as real-time or predicted temperature, real-time or predicted humidity, real-time or predicted wind, real-time or predicted air infiltration, real-time or predicted cloud cover, real-time or predicted angle of sun, real-time or predicted intensity of sun, real-time or predicted building occupancy, predicted or planned forced air ventilation, and cooling/heating capacity of the air conditioning and/or space heating system in the environment.

Additionally, the input(s) 42 may be used for entering settings of other customer preferences such as an upper comfort level temperature, a lower comfort level temperature, a highest acceptable temperature when the environment warmed is considered unoccupied, and a lowest acceptable temperature when the environment cooled is considered unoccupied.

The input(s) 42 may be a remote input that allows an off-site customer, operator, or utility provider to override the controller 10 and return the air conditioning and/or space heating system 50 to a normal operation. Preferably, the remote input is operable by a utility provider only particularly in extreme situations to avoid a brown-out or rolling blackout. In such situation a timing signal may optionally be sent that changes the pre-programmed/pre-designated peak period by advancing the starting time or extending the ending time. For example, the 3 p.m. to 9 p.m. peak period may be changed to 12 noon to 8 p.m. with a corresponding advance of the pre-operating period and/or a reduction in the operating level of the air conditioner operation in the pre-operating period that overlaps the extended period. This override may or may not include a change in the rate schedule as determined by the utility provider. Remote control of the controller may be accomplished by a conventional interface by internet, telephone, pager or similar line or wireless means. Although the controller 10 may include a remote input that can override the preset program, this feature can be omitted or access blocked where exclusive customer control is required or levels of priority can override settings when preferred, leaving remote control a customer option that can be controlled.

The controller 10 may coordinate with the sensor(s) 41 to receive additional inputs from the sensor(s) 41. The sensors 41 may sense the outdoor temperature, the indoor temperature, the indoor humidity, and the outdoor humidity. For example, the outdoor temperature may be measured by a sensor at the air entrance to a compressor, and the indoor temperature may be measured by a sensor at the air entrance to an evaporator. Similarly, the outdoor humidity may be measured by a sensor at the air entrance to the compressor, and the indoor humidity may be measured by a sensor at the entrance to the evaporator.

An indoor sensor 41 may be electronically connected to the controller 10 and configured to generate an input signal to the processor 11 representing an indoor parameter as one of the processing parameters including at least one of temperature and humidity. An outdoor sensor 41 may be electronically connected to the controller 10 and configured to generate an input signal to the processor 11 representing an outdoor parameter as one of the processing parameters including at least one of temperature and humidity.

The temperature measurements may be employed to predict the duration of the operation required for each period, such as when the time approaches the peak period, and to determine if additional cooling or heating is required at the end of the peak period.

The humidity measurements may be used to adjust the required temperature for activating the operation of the air conditioning and/or space heating system to effective comfort level settings selected by the customer. Additionally, the humidity measurements may be used as an important factor in determining speed and duration of an evaporator fan to prevent icing or excess condensation from accumulating on the evaporator when the air conditioner is operating at peak capacity or suspended during peak periods. Further, sensing both indoor and outdoor humidity is preferred to predict the change in the indoor humidity as the day progresses and implement adjustments in advance to accommodate an increasing or decreasing humidity level.

The sensor(s) 41 may also sense the wind, the air infiltration, the cloud cover, the angle of sun, the intensity of sun, or any other propriate environmental conditions. The sensor(s) 41 may also sense the building occupancy, for example, based on the door-accessing record. The real-time environmental conditions provided by the sensor(s) 41 may affect the control of the air conditioning and/or space heating system. With continuous real-time input from the environmental sensors as the day progresses, the schedule for the operation of the air conditioning and/or space heating system is periodically revised or modified. Also, with continuous real-time input from the environmental sensors as the day progresses, the schedule for the operation of forced outdoor air ventilation is periodically revised or modified.

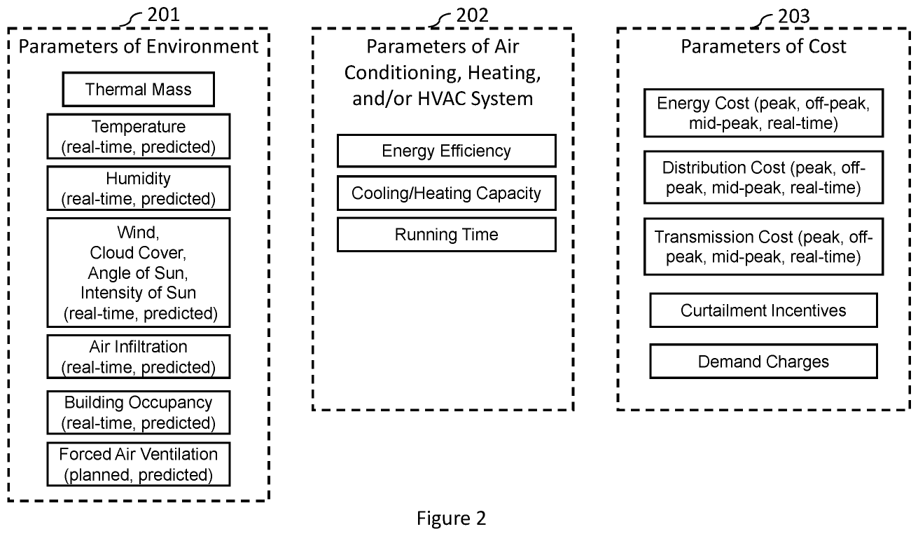

Referring to FIG. 2, the system may use a variety of processing parameters for a control system according to the present teachings, including but not limited to parameters of the environment 201, parameters of air conditioning and/or space heating system 202, and parameters of cost 203. The parameters of the environment 201 may include the thermal mass of the environment, the real-time or predicted temperature, the real-time or predicted humidity, the real-time or predicted wind, the real-time or predicted air infiltration, the real-time or predicted cloud cover, the real-time or predicted angle of sun, the real-time or predicted intensity of sun, the real-time or predicted building occupancy, and the predicted or planned forced air ventilation. The parameters of air conditioning and/or space heating system 202 may include the energy efficiency, the cooling/heating capacity, running time, etc. The parameters of cost 203 may include the peak energy cost, the off-peak energy cost, the real-time energy cost, the peak distribution cost, the off-peak distribution cost, the real-time distribution cost, the peak transmission cost, the off-peak transmission cost, the real-time transmission cost, demand charges, and the curtailment incentives. The parameters of cost 203 may also include the mid-peak energy cost, the mid-peak distribution cost, and the mid-peak transmission cost. Each cost described in the parameters of cost 203 may have multiple cost level.

The thermal mass of the environment refers to a property of the environment which enables building materials to absorb, store, and later release thermal energy to provide inertia against temperature fluctuations. The thermal mass (unit: J/° C.) may be calculated as a ratio of the thermal energy transferred to a change in temperature. Alternatively, the thermal mass (unit: J/K) may be calculated by multiplying the mass (unit: kg) of a uniform-composition body and the isobaric specific heat capacity (unit: J·kg⁻¹·K⁻¹) of the material. The thermal mass of the environment may be in a format of default values through the input(s) 42, or may be calculated and updated by a machine-learning algorithm after actual data for the environment are collected by the control system.

The real-time temperature, the real-time humidity, the real-time wind, the real-time air infiltration, the real-time cloud cover, the real-time angle of sun, the real-time intensity of sun may be received from the sensor(s) 41 or the input(s) 42. The predicted temperature, the predicted humidity, the predicted wind, the predicted air infiltration, the predicted cloud cover, the predicted angle of sun, the predicted intensity of sun may be received locally or remotely from the input(s) 42. Here, air infiltration refers to movement of outside air into a building, typically through cracks or the use of doors or windows, sometimes called air leakage, or required or desired fresh air infiltration and internal air removal.

The efficiency of the air conditioning and/or space heating system may be quantified by a coefficient of performance (COP)—a ratio of useful heating or cooling provided to energy required. The COP may be provided through the input(s) 42. The efficiency of the air conditioning and/or space heating system may be referenced by a heating/cooling time rate by using a look-up table. The look-up table may be generated by recording the heating/cooling time and the temperature changes for the actual environment in real time. In the case of that the air conditioning and/or space heating system has multiple operating levels, the efficiency is calculated for each operating level. Initially, default rates can be utilized which are approximated by considering the capacity of the air conditioner 51 or the fan 52 and the square footage of the environment to be warmed/cooled, which allows the controller 10 to be immediately implemented before the more accurate data is generated during actual use.

The cooling/heating capacity of the air conditioning and/or space heating system is a measurement of a cooling/heating system's ability to remove/generate heat. The cooling/heating capacity may be calculated by multiplying the mass rate (unit: kg/s), the specific heat capacity (unit: J·kg⁻¹·K⁻¹) by the temperature change (unit: K). The cooling/heating capacity of the air conditioning and/or space heating system may be in a format of default values through the input(s) 42, or may be calculated and updated by a machine-learning algorithm after actual data for the environment are collected by the control system. The running time of the air conditioning and/or space heating system refers to the duration that the air conditioning and/or space heating system has run for.

The parameters of costs for the consumption of energy may include at least one of: energy cost, distribution cost, transmission cost, demand charges, curtailment incentives. The energy cost may include peak energy cost, off-peak energy cost, real time energy cost, or mid-peak energy cost. The distribution cost may include peak distribution cost, off-peak distribution cost, mid-peak distribution cost, or real-time distribution cost. The transmission cost may include peak transmission cost, off-peak transmission cost, mid-peak transmission cost, or real-time transmission cost. Each cost may comprise multiple cost levels.

The energy cost refers to the cost the customer pays for using the energy, which may include costs for electricity, natural gas, fuel oil, propane, other fuel, or any applicable type of energy. Take electricity as an example, a standard electricity bill is calculated by multiplying a fixed rate the customer pays for electricity by the amount of electricity the customer has consumed in a month for a monthly bill. A time-of-use electricity bill is calculated by multiplying the amount of electricity consumed during certain hours of the day by the rate specific to those hours (e.g., peak electricity rate or off-peak electricity rate). A real-time electricity bill is calculated by the amount of electricity consumed real-time by the rate specific to real-time. In practice, the different types of bills mean that some customers may see different costs on their monthly electric bills without changing their behavior.

The distribution cost and transmission cost refer to the cost the customer pays for the infrastructure that allows energy to be brought to the customer, which include the costs of building wires and transmission lines for electricity or building pipes for natural gas, as well as upkeep and maintenance to ensure that customer has energy running when need.

The demand charges refer to the cost the customer pays for demands that is over planned or predicted demands of energy, including for example electricity and natural gas. The strategic-response control system uses demand charges as an economic component of the analysis for control to reduce air conditioning and/or space heating use and reduce electric or natural gas load while maintaining the building environment temperature within the desired range.

The curtailment incentives refer to the payments to alter consumption, energy sales taxes and state surcharges, including any incentives to reduce the consumption of energy, such as electricity or natural gas. State surcharges may include renewable energy incentives, energy efficiency incentives, assistance for low-income customers, payment for other energy programs, etc.

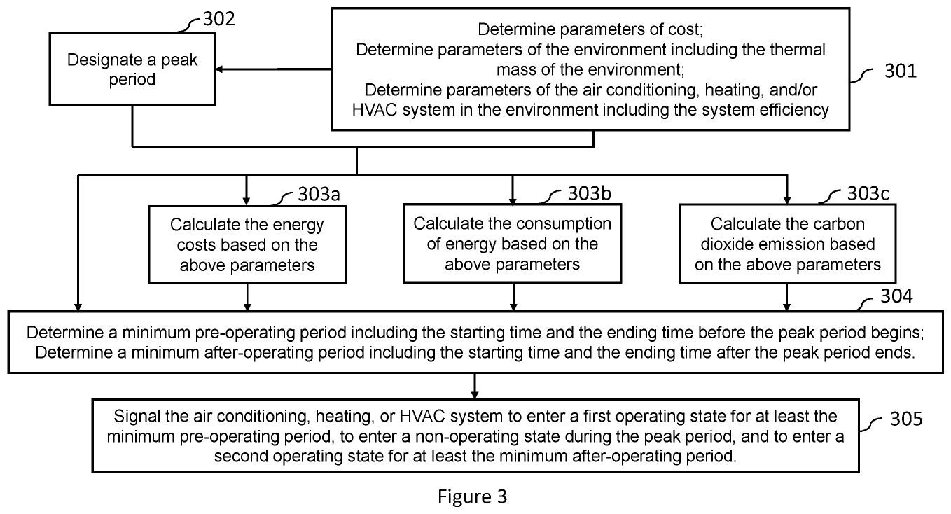

Referring to FIG. 3, a processing procedure for a control system according to one embodiment of the present teachings is illustrated.

In step 301, the processor may determine the parameters of cost including the cost related parameters described in FIG. 2, determine the parameters of the environment including the thermal mass of the environment as well as other environmental parameters described in FIG. 2, and determine the parameters of the air conditioning and/or space heating system in the environment including the efficiency of the air conditioning and/or space heating system as well as other air conditioning and/or space heating system related parameters described in FIG. 2. The processor may use the processing parameters and processing procedure in the operating program to determine which parameters are to be used in the control system. For example, the processor may have received information or value regarding certain parameters but not the other parameters, in this case, the processor may determine that only the parameters with received information or value will be used. As another example, the processor may determine that the parameters with no received information or value will be used by assigning a default or predicted information or value to these parameters. As a further example, the processor may determine whether a parameter that has both a real-time value and a predicted value will be used and which value of the parameter will be used.

In step 302, the processor in the control system may designate a peak period including a starting time and an ending time. For example, the processor may designate the peak period according to the information received from a utility provider, such as based on the energy rate in different time of a day. As another example, when the processor receives a notice on real-time or predicted insufficient energy generation or supply or elevated energy price in a region that includes the environment, the process may assign a time period including a starting time and an ending time as a designated peak period based on the notice. As another example, when the processor receives and analyzes energy generation or supply information in a region that includes the environment to predict an energy demand in the region, the processor may assign a time period as the designated peak period based on the prediction of the energy demand. As a further example, when the processor receives operation information of power plants in a region that includes the environment and analyzes carbon dioxide emission based on the operation information to predict carbon dioxide emission in the region, the processor may assign a time period as the designated peak period based on the prediction of the carbon dioxide emission. As a further example, when the processor receives information on curtailing full or partial operation of solar or wind power plants in a region that includes the environment for grid operational purpose, the processor may assign immediately or at a certain time point off a previously designated peak period based on the curtailing information.

The processor may use the information processed in step 301 to designate a peak period. For example, the processor may designate the peak period according to the parameters of cost, such as by assigning the highest rate period as the peak period. As another example, the processor may designate the peak period according to the parameters of environment, such as by assigning the starting time of a peak period when a real-time temperature is higher than a certain value. As a further example, the processor may designate the peak period according to the parameters of the air conditioning and/or space heating system in the environment, such as by assigning the ending time of a peak period when the air conditioning and/or space heating system runs over a certain duration.

In sum, the processor may smartly update and use the information received, processed, or recorded in the control system to designate a peak period. For example, the processor may use the information of energy supply and demand provided from the utility provider(s) or other sources to designate a peak period. As another example, the processor may use the information of carbon dioxide emission recorded by the control system or provided from the utility provider(s) or other sources to designate a peak period.

In step 303a, the processor may calculate or analyze the energy cost based on the parameters in the step 301 and the designated peak period. The calculation or analysis may result in an optimal operation mode that would have a minimum energy cost and define several time periods and the corresponding operation state of the air conditioning and/or space heating system for each of the time periods.

In step 303b, the processor may calculate or analyze the consumption of energy based on the parameters in the step 301 and the designated peak period. The calculation or analysis may result in an optimal operation mode that would have a minimum energy consumption and define several time periods and the corresponding operation state of the air conditioning and/or space heating system for each of the time periods.

In step 303c, the processor may calculate or analyze the carbon dioxide emission based on the parameters in the step 301 and the designated peak period. The calculation or analysis may result in an optimal operation mode that would have a minimum carbon dioxide emission and define several time periods and the corresponding operation state of the air conditioning and/or space heating system for each of the time periods.

In step 304, the processor may determine a minimum pre-operating period including the starting time and the ending time before the peak period begins, and the processor may also determine a minimum after-operating period including the starting time and the ending time after the peak period ends. The minimum pre-operating period and the minimum after-operating period may be determined by using a processing procedure having the parameters described in the step 302. Alternatively, the minimum pre-operating period and the minimum after-operating period may be determined by using the optimal operation mode with a minimum energy cost described in the step 303a, using the optimal operation mode with a minimum energy consumption described in the step 303b, or using the optimal operation mode with a minimum carbon dioxide emission described in the step 303c.

In step 305, the processor may signal the air conditioning and/or space heating system to enter a first operating state for at least the minimum pre-operating period, to enter a non-operating state during the peak period, and to enter a second operating state for at least the minimum after-operating period. The first operating state and the second operating state may be the same or different. For example, if the air conditioning and/or space heating system is operable only in one single mode without other different operating modes, the first operating state and the second operating state may mean that the air conditioning and/or space heating system is simply “on.” As another example, if the air conditioning and/or space heating system is operable in several different modes, e.g., a high level, a middle level, and a low level, the first operating state and the second operating state may mean different levels.

It is to be understood that although both pre-operating period and after-operating period are illustrated here, it is not necessarily to have both. Preferably, the control system includes at least one pre-operating period for at least one peak period.

In the case of the operating state of the air conditioning and/or space heating system has multiple power levels including a low-power level, the processing parameters and processing procedure may include designating a comfort level temperature; determining whether the comfort level temperature will be exceeded in the designated peak period by operating the air conditioning and/or space heating system in the non-operating state during the designated peak period; and determining a minimum peak-operating period using the thermal mass of the environment and the efficiency of the air conditioning and/or space heating system if it is determined that the comfort level temperature will be exceeded in the designated peak period by operating the air conditioning and/or space heating system in the non-operating state during the designated peak period. As such, the processor may determine the minimum pre-operating period and to signal the air conditioning and/or space heating system to enter the operating state at the low power level for at least the minimum peak-operating period during the designated peak period.

The minimum peak-operating period may be calculated by using at least one of: parameters of the environment, parameters of the air conditioning and/or space heating system, and parameters of cost. The parameters of the environment may include thermal mass: temperature, humidity, wind, air infiltration, cloud cover, angle of sun, intensity of sun, predicted temperature, humidity, wind, air infiltration, cloud cover, angle of sun, intensity of sun, forced air ventilation, and cooling/heating capacity of the air conditioning and/or space heating system in the environment. The parameters of the air conditioning and/or space heating system may include the energy efficiency and cooling/heating capacity. The parameters of costs may include the peak, off-peak, mid-peak, real-time energy cost, the peak, off-peak, or mid-peak distribution cost, the peak, off-peak, or mid-peak transmission cost, demand charges, and curtailment incentives.

The minimum peak-operating period may be calculated by sensing an indoor temperature and sensing an outdoor temperature, determining a warmup or cooldown rate for the environment based on the indoor temperature and the outdoor temperature; and calculating the minimum peak-operating period using the warmup or cooldown rate.

In the case of the operating state of the air conditioning and/or space heating system has at least three power levels including the low power level and a next power level above the low power level, the processing parameters and processing procedure may include determining whether the minimum peak-operating period exceeds a remaining time period of the designated peak period, and calculating a second minimum peak-operating period using the thermal mass of the environment and the efficiency of the air conditioning and/or space heating system if it is determined that the minimum peak-operating period exceeds the remaining time period of the designated peak period. As such, the processor may signal the air conditioning and/or space heating system to operate at the next power level above the low power level for at least the second minimum peak-operating period during the designated peak period.

The processing parameters and processing procedure may comprise calculating a warmup or cooldown rate for the environment, and the operating program may include an algorithm for calculating the warmup or cooldown rate for the environment for a particular indoor temperature and a particular outdoor temperature. In the case of the operating state of the air conditioning and/or space heating system has multiple power levels, the warmup or cooldown rate for the environment may be calculated by using a table of relationship between warmup or cooldown rates and power levels of the operating state.

It is to be understood that the control system according to the present teachings may be compatibly used with a normal operation. The normal operation occurs when there is no request by the utility or customer to use a control system according to the present teachings. For example, normal operation occurs where there may be no peak rate differentials and simple economic operation is desired. Similarly, the control system may be preprogrammed as a standing request for each weekday where peak rates are in effect. This setting may be accomplished by a signal from the utility provider or customer, or alternately preset as default for maximized energy savings (minimum energy cost), or minimum carbon oxide emissions. It is to be understood that the protocol described provides a basic algorithm for accomplishing the energy savings or carbon oxide emission reductions in the environment and may be modified or enhanced without departing from the concepts of this invention.

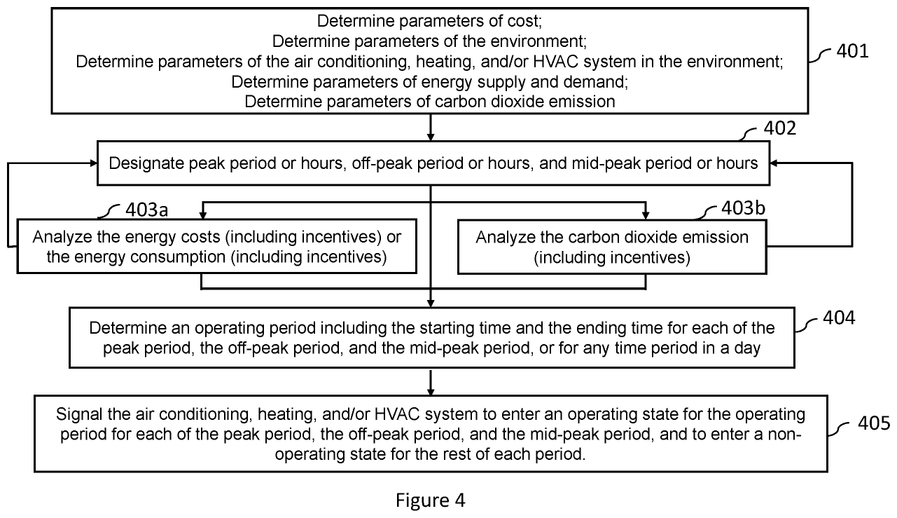

Referring to FIG. 4, a processing procedure for a control system according to another embodiment of the present teachings is illustrated.

In step 401, the processor may determine the parameters of cost including the cost related parameters described in FIG. 2, determine the parameters of the environment including the thermal mass of the environment as well as other environmental parameters described in FIG. 2, and determine the parameters of the air conditioning and/or space heating system in the environment including the efficiency of the air conditioning and/or space heating system as well as other air conditioning and/or space heating system related parameters described in FIG. 2. The processor may also determine the parameters of energy supply and demand including, for example, the operating status of each power plant in a region that includes the environment and the demand of the energy in a region that includes the environment. The processor may also determine the parameters of carbon dioxide emission including, for example, the real-time or predicted carbon dioxide emission of the environment, recorded carbon dioxide emission of the environment, the real-time or predicted carbon dioxide emission of the region that includes the environment, or recorded carbon dioxide emission of the region that includes the environment.

The processor in the control system may designate a peak period, an off-peak period, and a mid-peak period, each including a starting time and an ending time in step 401. It is to be understood that the processor may designate at least one peak period and at least one off-peak or mid-peak period, or any combination thereof.

For example, the processor may designate the peak period, the off-peak period, and the mid-peak period according to the information received from a utility provider, such as based on the energy rate in different time of a day. As another example, when the processor receives a notice on real-time or predicted insufficient energy generation or supply or elevated energy price in a region that includes the environment, the process may assign a time period including a starting time and an ending time as a designated peak period or a designated mid-peak period based on the notice. As another example, when the processor receives and analyzes energy generation or supply information in a region that includes the environment to predict an energy demand in the region, the processor may assign a time period as the designated peak period or a designated mid-peak period based on the prediction of the energy demand. As a further example, when the processor receives operation information of power plants in a region that includes the environment and analyzes carbon dioxide emission based on the operation information to predict carbon dioxide emission in the region, the processor may assign a time period as the designated peak period or a designated mid-peak period based on the prediction of the carbon dioxide emission. As a further example, when the processor receives information on curtailing full or partial operation of solar or wind power plants in a region that includes the environment for grid operational purpose, the processor may assign immediately or at a certain time point off a previously designated peak period or assign a time period as a designated off-peak or mid-peak period based on the curtailing information.

The processor may use the information processed in step 401 to designate the peak period, the off-peak period, and the mid-peak period. Here, the period may refer to a continuous time period or include at least two intermittent time periods. The unit for the period may be hour, minute, or second. For example, the processor may designate the peak period, the off-peak period, and the mid-peak period according to the parameters of cost, such as by assigning the highest rate period as the peak period or assigning the lowest rate period as off-peak period. As another example, the processor may designate the peak period, the off-peak period, and the mid-peak period according to the parameters of environment, such as by assigning the starting time of a peak period when a real-time temperature is higher than a certain value or assigning the ending time of a peak period when a real-time temperature is lower than a certain value. As a further example, the processor may designate the peak period, the off-peak period, and the mid-peak period according to the parameters of the air conditioning and/or space heating system in the environment, such as by assigning the ending time of a peak period when the air conditioning and/or space heating system runs over a certain duration or by assigning the starting time of a peak period when the air conditioning and/or space heating system have not run over a certain duration. As a further example, the processor may use the information of energy supply and demand provided from the utility provider(s) or other sources to designate the peak period, the off-peak period, and the mid-peak period. As a further example, the processor may use the information of carbon dioxide emission recorded by the control system or provided from the utility provider(s) or other sources to designate the peak period, the off-peak period, and the mid-peak period.

In sum, the processor may smartly update and use the information received, processed, or recorded in the control system to designate a peak period, an off-peak period, and a mid-peak period. For example, the processor may designate the peak period, the off-peak period, and the mid-peak period according to the analysis of the energy costs (including incentives) or the energy consumption (including incentives) described in step 403a, or the analysis of the carbon dioxide emission (including incentives) described in step 403b.

In step 403a, the processor may calculate or analyze the energy cost or the energy consumption. The calculation or analysis may be based on the information received, processed, or recorded in the control system, including the parameters in the step 401. The calculation or analysis may result in an optimal operation mode that would have a minimum energy cost or a minimum energy consumption and define several time periods and the corresponding operation state of the air conditioning and/or space heating system for each of the time periods. The calculation or analysis may include analysis of incentives such as incentives for lower energy cost or lower energy consumption.

In step 403b, the processor may calculate or analyze the carbon dioxide emission. The calculation or analysis may be based on the information received, processed, or recorded in the control system, including the parameters in the step 401. The calculation or analysis may result in an optimal operation mode that would have a minimum carbon dioxide emission and define several time periods and the corresponding operation state of the air conditioning and/or space heating system for each of the time periods. The calculation or analysis may include analysis of incentives such as incentives for lower carbon dioxide emission.

In step 404, the processor may determine an operating period including the starting time and the ending time for each of the peak period, the off-peak period, and the mid-peak period that has been designated in the step 401. It is noted that determining an operating period may also apply to any time period in a day. For example, the processor may determine an operating period including the starting time and the ending time for a time period that has not been designated as peak, off-peak, or mid-peak period. It is to be understood that in the case of at least one peak period and at least one off-peak or mid-peak period or any combination thereof have been designated, the processor may determine an operating period including the starting time and the ending time for each of them.

The operating period may be determined by using a processing procedure having the parameters described in step 402. Alternatively, the operating period may be determined by using the optimal operation mode with a minimum energy cost or a minimum energy consumption described in step 403a, or using the optimal operation mode with a minimum carbon dioxide emission described in step 403b. For example, if a customer concerns more about the cost, the operating period may be determined by using the optimal operation mode with a minimum energy cost. Or if a customer concerns more about the environmental effect such as energy consumption or carbon dioxide emission, the operating period may be determined by using the optimal operation mode with a minimum energy consumption or a minimum carbon dioxide emission. It is possible that operating period may be determined by considering all analysis in steps 403a and 403b for an optimal combined result, such as so that both cost and environmental effect are not badly sacrificed.

The operating period for each of the periods may comprise multiple operating levels and multiple time sections, and for each time section it has its own operating level. For example, if an operating period for an off-peak period is from 7 am to 10 am, 7 am to 8 am may be a high-level operating period, 8 am to 9 am may be a mid-level operating period, and 9 am-10 am may be a low-level operating period. The operating period may be non-existence for a certain period. For example, in some cases, the operating period for a peak period may be non-existence, i.e., the air conditioning and/or space heating system does not operate during the peak period.

In step 405, the processor may signal the air conditioning and/or space heating system to enter the operating state for each of the peak period, the off-peak period, and the mid-peak period that has been determined in the step 404, and to enter a non-operating state for the rest of each period. If the operating period comprises multiple operating levels and multiple time sections, the processor may signal the air conditioning and/or space heating system to enter the corresponding level of the operating state with the certain starting time and the certain ending time of the corresponding time section. That is, the processor may signal the air conditioning and/or space heating system to operate with various adjustment times, with various time sequences, and/or with various starting/ending times. For example, if an off-peak period is from 7 am to 11 am and the operating period for the off-peak period is from 7 am to 10 am, the processor may signal the air conditioning and/or space heating system to enter a high-level operating state from 7 am to 8 am, to enter a mid-level operating state from 8 am to 9 am, to enter a low-level operating state from 9 am-10 am, and to enter a non-operating state (i.e., “off”) from 10 am-11 am.

It is to be understood that the control system according to the present teachings may be compatibly used with a normal operation. The normal operation occurs when there is no request by the utility or customer to use a control system according to the present teachings. For example, normal operation occurs where there may be no peak rate differentials and simple economic operation is desired. Similarly, the control system may be preprogrammed as a standing request for each weekday where peak rates are in effect. This setting may be accomplished by a signal from the utility provider or customer, or alternately preset as default for maximized energy savings (minimum energy cost), or minimum carbon oxide emissions. It is to be understood that the protocol described provides a basic algorithm for accomplishing the energy savings or carbon oxide emission reductions in the environment and may be modified or enhanced without departing from the concepts of this invention.

It should be understood to a person of ordinary skill in the art that the foregoing process may be modified according to the customer or the utility objectives. For example, the arrangement and order of the operating period may differ from those described in the above written description and figures without departing from the scope and spirit of the present teachings. The processing parameters and the processing procedures may also differ from those described in the above written description and figures without departing from the scope and spirit of the present teachings.

While the present teachings have been described above in terms of specific embodiments, it is to be understood that they are not limited to those disclosed embodiments. Many modifications and other embodiments will come to mind to those skilled in the art to which this pertains, and which are intended to be and are covered by both this disclosure and the appended claims. For example, in some instances, one or more features disclosed in connection with one embodiment can be used alone or in combination with one or more features of one or more other embodiments. It is intended that the scope of the present teachings should be determined by proper interpretation and construction of any claims and their legal equivalents, as understood by those of skill in the art relying upon the disclosure in this specification and the attached drawings.

What is claimed is:

1. A control system for controlling consumption of energy in an environment, the control system comprising:
a controller having a processor and a real time clock, the real time clock being configured to coordinate operations of the processor with timing of the designated peak period, the processor being configured to determine a minimum pre-operating period and to signal an air conditioning and/or space heating system to enter an operating state for at least the minimum pre-operating period before the designated peak period begins and enter a non-operating state after the designated peak period begins;
an operating program having processing parameters and processing procedure for determining the minimum pre-operating period, wherein the processing parameters and processing procedure comprise determining the minimum pre-operating period using thermal mass of the environment, costs for the consumption of energy, and efficiency of the air conditioning and/or space heating system.

2. The control system of claim 1, wherein the energy comprises at least one of electricity and natural gas, and further comprising the air conditioning and/or space heating system in the environment that is alternately operated in the operating state and the non-operating state.

3. The control system of claim 1, wherein the processing parameters and processing procedure further comprise determining the minimum pre-operating period using at least one of: real-time temperature, real-time humidity, real-time wind, real-time air infiltration, real-time cloud cover, real-time angle of sun, real-time intensity of sun, real-time building occupancy, predicted temperature, predicted humidity, predicted wind, predicted air infiltration, predicted cloud cover, predicted angle of sun, predicted intensity of sun, predicted building occupancy, predicted or planned forced air ventilation, and cooling/heating capacity of the air conditioning and/or space heating system in the environment.

4. The control system of claim 1, wherein the costs for the consumption of energy further comprise at least one of: peak energy cost, off-peak energy cost, real time energy cost, peak distribution cost, off-peak distribution cost, peak transmission cost, off-peak transmission cost, demand charges and curtailment incentives.

5. The control system of claim 4, wherein each of the peak energy cost, off-peak energy cost, real time energy cost, peak distribution cost, off-peak distribution cost, peak transmission cost, and off-peak transmission cost comprises multiple cost levels.

6. The control system of claim 1, wherein the processor is further configured to:
receive a notice on current or expected insufficient energy generation or supply or elevated energy price in a region that includes the environment; and
assign a time period as the designated peak period based on the notice.

7. The control system of claim 1, wherein the processor is further configured to:
receive and analyze energy generation or supply information in a region that includes the environment to predict an energy demand in the region; and
assign a time period as the designated peak period based on the prediction of the energy demand.

8. The control system of claim 1, wherein the processor is further configured to:
receive operation information of power plants in a region that includes the environment and analyze carbon dioxide emission based on the operation information to predict carbon dioxide emission in the region;
assign a time period as the designated peak period based on the prediction of the carbon dioxide emission.

9. The control system of claim 1, wherein the processor is further configured to:
receive information on curtailing full or partial operation of solar or wind power plants in a region that includes the environment for grid operational purpose,
assign immediately or at a designated time period off the designated peak period based on the curtailing information.

10. The control system of claim 1, further comprising:
an indoor sensor electronically connected to the controller and being configured to generate an input signal to the processor representing an indoor parameter as one of the processing parameters including at least one of temperature and humidity;
an outdoor sensor electronically connected to the controller and being configured to generate an input signal to the processor representing an outdoor parameter as one of the processing parameters including at least one of temperature and humidity;
a storage configured to store parameters of the environment, parameters of the air conditioning and/or space heating system, and parameters of cost for use in the processing parameters and processing procedure.

11. The control system of claim 1, wherein the operating state of the air conditioning and/or space heating system has multiple power levels including a low power level,
wherein the processing parameters and processing procedure further comprises: designating a comfort level temperature; determining whether the comfort level temperature will be exceeded in the designated peak period by operating the air conditioning and/or space heating system in the non-operating state during the designated peak period; and determining a minimum peak-operating period using the thermal mass of the environment and the efficiency of the air conditioning and/or space heating system if it is determined that the comfort level temperature will be exceeded in the designated peak period by operating the air conditioning and/or space heating system in the non-operating state during the designated peak period; and
wherein the processor is configured to determine the minimum pre-operating period and to signal the air conditioning and/or space heating system to enter the operating state at the low power level for at least the minimum peak-operating period during the designated peak period.

12. The control system of claim 1, wherein the processing parameters and processing procedure further comprises calculating a warmup or cooldown rate for the environment, and wherein the operating program includes an algorithm for calculating the warmup or cooldown rate for the environment for a particular indoor temperature and a particular outdoor temperature.

13. The control system of claim 12, wherein the operating state of the air conditioning and/or space heating system has multiple power levels, and wherein the processing parameters and processing procedure further comprises calculating the warmup or cooldown rate for the environment using a table of relationship between warmup or cooldown rates and power levels of the operating state.

14. The control system of claim 1, further comprising a metering device configured to record the consumption of energy; and an analyzing device configured to analyze a consumption change or a related carbon dioxide emission change based on the consumption record.

15. The control system of claim 14, wherein the analyzing device is further configured to generate a certifiable report on a reduction of energy consumption or related carbon dioxide emission.

16. A method for strategically controlling consumption of energy in an environment, the method comprising:
(1) calculating a minimum pre-operating period using thermal mass of the environment, efficiency of the air conditioning and/or space heating system, and costs for the consumption of energy;
(2) operating an air conditioning and/or space heating system in the environment in an operating state for at least the minimum pre-operating period before a designated peak period begins; and,
(3) operating the air conditioning and/or space heating system in a non-operating state after the designated peak period begins.

17. The method of claim 16, further comprising:
receiving a notice on current or expected insufficient energy generation or supply or elevated energy price in a region that includes the environment; and
assigning a time period as the designated peak period based on the notice.

18. The method of claim 16, further comprising:
receiving and analyzing energy generation or supply information in a region that includes the environment to predict an energy demand or price in the region; and
assigning a time period as the designated peak period based on the prediction of the energy demand or price.

19. The method of claim 16, further comprising:
receiving operation information of power plants in a region that includes the environment and analyzing carbon dioxide emission based on the operation information to predict carbon dioxide emission in the region;
assigning a time period as the designated peak period based on the prediction of the carbon dioxide emission.

20. The method of claim 16, further comprising:
receiving information on curtailing full or partial operation of solar or wind power plants in a region that includes the environment for grid operational purpose,
assigning immediately or at a designated time period off the designated peak period based on the curtailing information.

21. The method of claim 16, further comprising calculating the minimum pre-operating period using at least one of: temperature, humidity, wind, air infiltration, cloud cover, angle of sun, intensity of sun, predicted temperature, humidity, wind, air infiltration, cloud cover, angle of sun, intensity of sun, forced air ventilation, and cooling/heating capacity of the air conditioning and/or space heating system in the environment.

22. The method of claim 16, wherein the costs for the consumption of energy comprises at least one of: peak energy cost, off-peak energy cost, peak distribution cost, off-peak distribution cost, real time energy cost, peak transmission cost, off-peak transmission cost, demand charges, and curtailment incentives.

23. The method of claim 22, wherein each of the peak energy cost, off-peak energy cost, real time energy cost, peak distribution cost, off-peak distribution cost, peak transmission cost, and off-peak transmission cost comprises multiple cost levels.

24. The method of claim 16, wherein the operating state of the air conditioning and/or space heating system has multiple power levels including a low power level, further comprising:
(1) designating a comfort level temperature in the environment;
(2) determining whether the comfort level temperature will be exceeded in the designated peak period by operating the air conditioning and/or space heating system in the non-operating state during the designated peak period;
(3) calculating a minimum peak-operating period using the thermal mass of the environment and the efficiency of the air conditioning and/or space heating system if it is determined that the comfort level temperature will be exceeded in the designated peak period by operating the air conditioning and/or space heating system in the non-operating state during the designated peak period; and
(4) operating the air conditioning and/or space heating system at the low power level for at least the minimum peak-operating period during the designated peak period.

25. The method of claim 24, further comprising calculating the minimum peak-operating period using at least one of: parameters of the environment, parameters of the air conditioning and/or space heating system, and parameters of cost.

26. The method of claim 24, further comprising:
(1) sensing an indoor temperature and sensing an outdoor temperature;
(2) determining a warmup or cooldown rate for the environment based on the indoor temperature and the outdoor temperature; and,
(3) calculating the minimum peak-operating period using the warmup or cooldown rate.

27. The method of claim 24, wherein the operating state of the air conditioning and/or space heating system has at least three power levels including the low power level and a next power level above the low power level, further comprising:
(1) determining whether the minimum peak-operating period exceeds a remaining time period of the designated peak period;
(2) calculating a second minimum peak-operating period using the thermal mass of the environment and the efficiency of the air conditioning and/or space heating system if it is determined that the minimum peak-operating period exceeds the remaining time period of the designated peak period;
(3) operating the air conditioning and/or space heating system at the next power level above the low power level for at least the second minimum peak-operating period during the designated peak period.

28. The method of claim 27, further comprising calculating the second minimum peak-operating period using at least one of: parameters of the environment, parameters of the air conditioning and/or space heating system, and parameters of cost.

29. The method of claim 16, further comprising designating a peak period.

30. The method of claim 29, wherein designating the peak period is based on at least one of: parameters of the environment, parameters of the air conditioning and/or space heating system, parameters of cost, parameters of energy supply and demand, and parameters of carbon dioxide emission.

31. The method of claim 16, further comprising analyzing an energy cost.

32. The method of claim 31, further comprising calculating the minimum pre-operating period based on the analysis of the energy cost.

33. The method of claim 16, further comprising analyzing an energy consumption.

34. The method of claim 33, further comprising calculating the minimum pre-operating period based on the analysis of the energy consumption.

35. The method of claim 16, further comprising analyzing a carbon dioxide emission.

36. The method of claim 35, further comprising calculating the minimum pre-operating period based on the analysis of the carbon dioxide emission.

37. The method of claim 16, further comprising recording the consumption of energy; and analyzing a consumption change based on the consumption record.

38. The method of claim 37, further comprising analyzing a carbon dioxide emission change based on the consumption record.

39. The method of claim 16, further comprising generating a certifiable report on a reduction of energy consumption or carbon dioxide emission to be used for carbon dioxide emission credit's purpose, economic purpose, regulatory purpose, or regulatory compliance.

40. A control system for controlling consumption of energy in an environment, the control system comprising:
a controller having a processor and a real time clock, the real time clock being configured to coordinate operations of the processor with timing of a period, the processor being configured to designate a peak period and an off-peak period, determine a first operating period for the designated peak period and to signal an air conditioning and/or space heating system to enter a first operating state for at least the first operating period during the designated peak period and enter a non-operating state for rest of the designated peak period, and determine a second operating period for the designated off-peak period and to signal the air conditioning and/or space heating system to enter a second operating state for at least the second operating period during the designated off-peak period and enter the non-operating state for rest of the designated off-peak period;
an operating program having processing parameters and processing procedure for determining the first operating period and the second operating period, wherein the processing parameters and processing procedure comprises determining the first operating period and the second operating period using thermal mass of the environment, costs for the consumption of energy, and efficiency of the air conditioning and/or space heating system.

41. The control system of claim 40, wherein the processing parameters and processing procedure further comprises determining the first operating period and the second operating period using parameters of the environment and parameters of the air conditioning and/or space heating system in the environment.

42. The control system of claim 41, wherein the parameters of the environment comprise real-time temperature, real-time humidity, real-time wind, real-time air infiltration, real-time cloud cover, real-time angle of sun, real-time intensity of sun, real-time building occupancy, predicted temperature, predicted humidity, predicted wind, predicted air infiltration, predicted cloud cover, predicted angle of sun, predicted intensity of sun, predicted building occupancy, and
wherein the parameters of the air conditioning and/or space heating system in the environment comprise cooling/heating capacity of the air conditioning and/or space heating system and running time of the air conditioning and/or space heating system.

43. The control system of claim 40, wherein the costs for the consumption of energy comprise peak energy cost, off-peak energy cost, real-time energy cost, peak distribution cost, off-peak distribution cost, real-time distribution cost, peak transmission cost, off-peak transmission cost, real-time transmission cost, demand charges, and curtailment incentives.

44. The control system of claim 40, wherein designating the peak period and the off-peak period is based on at least one of: parameters of the environment, parameters of the air conditioning and/or space heating system, parameters of cost, parameters of energy supply and demand, and parameters of carbon dioxide emission.

45. The control system of claim 40, wherein the processor is further configured to analyze an energy cost.

46. The control system of claim 45, wherein the processor is further configured to determine the first operating period and the second operating period based on the analysis of the energy cost.

47. The control system of claim 40, wherein the processor is further configured to analyze an energy consumption.

48. The control system of claim 47, wherein the processor is further configured to determine the first operating period and the second operating period based on the analysis of the energy consumption.

49. The control system of claim 40, wherein the processor is further configured to analyze a carbon dioxide emission.

50. The control system of claim 49, wherein the processor is further configured to determine the first operating period and the second operating period based on the analysis of the carbon dioxide emission.
